(19) United States
(12) Patent Application Publication
(10) Pub. No.: US 2026/0276163 A1
(43) Pub. Date: Sep. 17, 2026

(54) LIGHT GUIDE COMPONENT, LIGHTING OR SIGNAL INDICATION DEVICE AND MOTOR VEHCILE

(71) Applicants: FOSHAN ICHIKOH VALEO AUTO LIGHTING SYSTEMS CO., LTD, Foshan Guangdong (CN); VALEO VISION, Bobigny (FR)

(72) Inventors: Xingang SHI, Foshan (CN); Yujun LI, Foshan (CN); Yamei LI, Foshan (CN)

(73) Assignee: VALEO VISION, Bobigny (FR)

(21) Appl. No.: 19/168,352

(22) PCT Filed: Mar. 25, 2024
(86) PCT No.: PCT/CN2024/083471

§ 371 Date: Sep. 24, 2025

(30) Foreign Application Priority Data
Mar. 27, 2023 (CN) 202320638770.3

(51) Int. Cl. F21S 41/24; F21S 41/36; F21S 41/37; F21S 41/60; F21S 43/20; F21S 43/236; F21S 43/242; F21S 43/31; F21W 102/13; F21W 103/55

(52) U.S. Cl. CPC F21S 41/24; F21S 41/36; F21S 41/37; F21S 41/60; F21S 43/236; F21S 43/246; F21S 43/26231; F21S 43/31; F21W 2102/13; F21W 2103/55

(57) ABSTRACT

The present disclosure provides a light guide component, a lighting or signal indication device with a light guide component, and a motor vehicle. The light guide component includes a main body portion provided with a first light output region, and a first light input portion configured to receive and guide a first light beam from a first light source into the main body portion, so that the first light beam is guided in the main body portion and exits from the first light output region to fulfil a first light function. The main body portion includes a second light output region. The light guide component also includes a second light input portion and a reflective portion, the second light input portion is configured to receive and guide a second light beam from a second light source into the main body portion.

### TECHNICAL FIELD

The present disclosure relates to the field of lighting and/or signal indication, and more specifically, to a light guide component, a lighting/signal indication device equipped with such a light guide component, and a motor vehicle.

### BACKGROUND OF THE INVENTION

In a number of fields, various lighting or signal indication devices are known to be used for providing light for lighting or signal indication. For example, vehicle lamps are used in motor vehicles to provide lighting or signaling functions, in order to ensure safe driving or provide an ornamental function.

Light guides, as optical elements, are often used in vehicle lamps of motor vehicles to guide light from light sources to desired positions or directions. Usually, various types of vehicle lamps are needed on motor vehicles to fulfil different functions. In conventional technology, different vehicle lamps are arranged independently, wherein, for example, full beam headlamps, dipping headlamps, daytime running lamps, parking lamps, etc., have respective optical systems comprising light guides, requiring independent installation space, which leads to an increase in overall volumes or sizes of all vehicle lamps, and makes the assembly of vehicle lamp components more complex.

### SUMMARY OF THE INVENTION

An objective of the present disclosure is to solve at least one of the problems and shortcomings of the prior art.

An embodiment of one aspect of the present disclosure provides a light guide component comprising a main body portion provided with a first light output region; and a first light input portion configured to receive and guide a first light beam from a first light source into the main body portion, so that the first light beam is guided in the main body portion and exits from the first light output region to fulfil a first light function; the main body portion is further provided with a second light output region, the light guide component further comprises a second light input portion and a reflective portion, the second light input portion is constructed to receive and guide a second light beam from a second light source into the main body portion and propagate same towards the reflective portion, and the reflective portion is constructed to receive a second light beam from a second light source and reflect the second light beam towards the second light output region to fulfil a second light function different from the first light function.

In some embodiments, the main body portion has a first reflective surface and a light output end face, the first light output region is defined on the light output end face, and the first reflective surface is arranged such that a first light beam entering the main body portion through the first light input portion is reflected by the first reflective surface towards the light output end face to exit from the first light output region.

In some embodiments, the second light input portion and the second light output region are located on the side of the main body portion opposite the reflective portion, so that a second light beam from a second light source enters the main body portion through the second light input portion and continues to propagate towards the reflective portion, and, after being reflected by the reflective portion, the second light beam enters the main body portion again to exit from the second light output region.

In some embodiments, the main body portion further has a first surface and a second surface that are arranged opposite each other, the first and second surfaces being adjacent to the first reflective surface and light output end faces, a second light output region is defined on the first surface, the second light input portion is formed on the first surface separating from the second light output region, and the reflective portion is formed on the second surface.

In some embodiments, the reflective portion has a second reflective surface and a third reflective surface arranged opposite each other, the second reflective surface is constructed and arranged to reflect the second light beam propagating through the main body portion towards the third reflective surface, and the third reflective surface is constructed and arranged to reflect the second light beam reflected from the second reflective surface into the main body portion so that the light beam exits from the second light output region.

In some embodiments, the reflective portion is formed as a boss protruding from the second surface, the boss having a trapezoidal cross section in a plane perpendicular to a first direction, wherein the lines intersecting the second and third reflective surfaces with the plane respectively define the sides of the trapezoidal cross section.

In some embodiments, the second reflective surface and the third reflective surface are inclined relative to a second direction, so that the distance therebetween in a third direction gradually increases in the direction of emergence of first functional light.

In some embodiments, in a first direction, the second light output region is closer to the light output end face than the second light input portion.

In some embodiments, an optical pattern structure is formed in the second light output region, the optical pattern structure being configured to shape an emergent second light beam into a desired light distribution.

In some embodiments, at least one of the first light input portion and the second light input portion comprises a light collimating portion.

An embodiment of another aspect of the present disclosure further provides a lighting or signal indication device, comprising a light guide component as described in any one embodiment of the present disclosure; a first light source for providing a first light beam to the first light input portion; and a second light source for providing a second light beam to the second light input portion.

An embodiment of yet another aspect of the present disclosure further provides a motor vehicle comprising a light guide component or lighting or signal indication device as described in any one embodiment of the present disclosure.

A detailed description of the present disclosure below with reference to the drawings will make other objectives and advantages of the present disclosure apparent and help to gain a comprehensive understanding of the present disclosure.

### BRIEF DESCRIPTION OF THE DRAWINGS

These and/or other aspects, features and advantages of the present disclosure will become apparent and readily understood from the following description of some illustrative embodiments in conjunction with the accompanying drawings. In the drawings:

FIG. 1 is a perspective schematic diagram of a light guide component installed on a decorative ring of a vehicle lamp according to an exemplary embodiment of the present disclosure;

FIG. 2 is a front perspective diagram schematically illustrating the structure of a light guide component according to an exemplary embodiment of the present disclosure;

FIG. 3 is a lateral perspective view of the structure of a light guide component according to an exemplary embodiment of the present disclosure, schematically showing the optical path of first functional light in the light guide component;

FIG. 4 is another lateral perspective view of the structure of a light guide component according to an exemplary embodiment of the present disclosure; and

FIG. 5 is a front view of the structure of a light guide component according to an exemplary embodiment of the present disclosure, schematically showing the optical path of second functional light in the light guide component.

### DETAILED DESCRIPTION OF THE INVENTION

Embodiments of the present disclosure will be described in detail below in conjunction with the attached drawings. In this description, the same or similar components are indicated by the same or similar reference numerals.

In addition, in the following detailed description, for ease of explanation, many specific details are given to provide a comprehensive understanding of embodiments of the present disclosure. However, it is obvious that one or more embodiments may also be implemented without these specific details. In other scenarios, well-known structures and devices are shown in the form of illustrations to simplify the drawings.

The following description of exemplary embodiments of the present disclosure with reference to the drawings is intended to make clear the inventive concept of the present disclosure, rather than being construed as a limitation of the present disclosure.

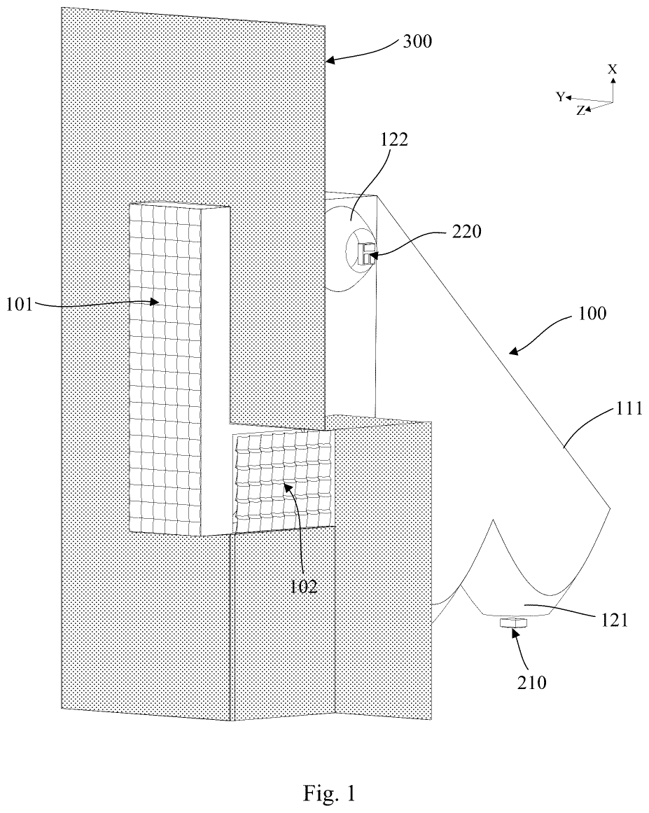

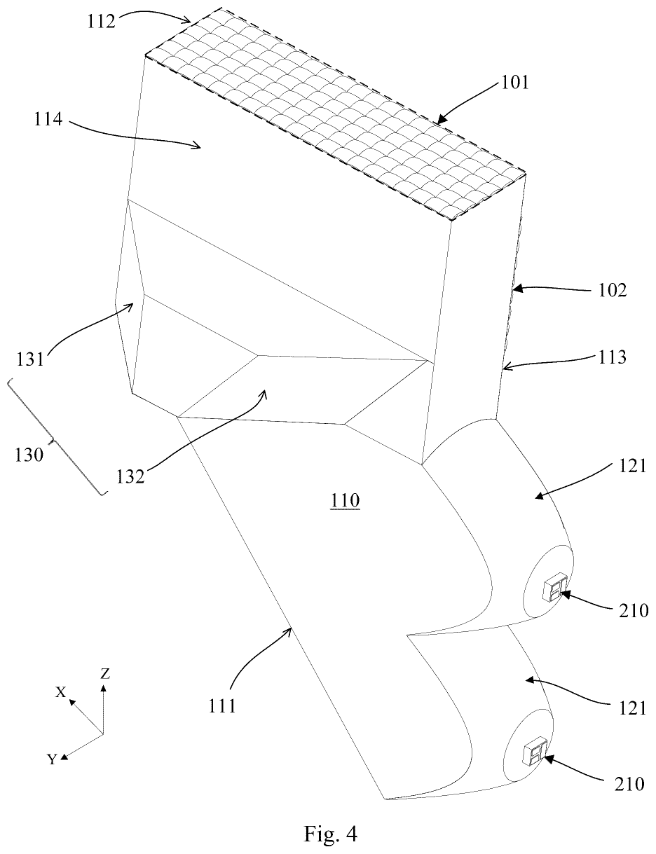

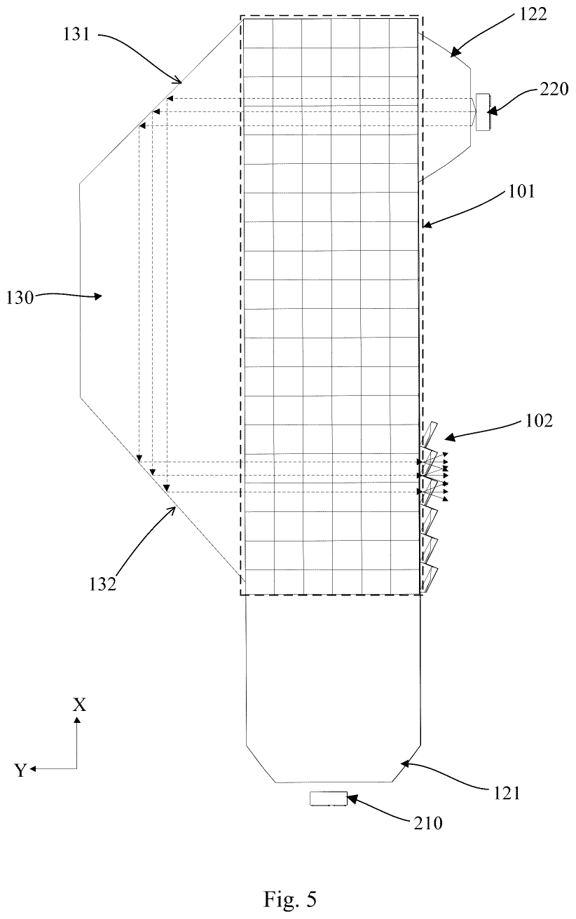

FIG. 1-5 schematically show the structures of light guide components according to exemplary embodiments of the present disclosure. As described below, the light guide component provided in an exemplary embodiment of the present disclosure is applicable to various optical modules, such as lighting or signal indication devices, like headlamps in motor vehicles, the light guide component being able to provide guidance for two types of functional light or provide two types of light intended for lighting or signal indication.

As shown in FIG. 1-5, a light guide component 100 according to an exemplary embodiment of the present disclosure comprises a main body portion 110 and a first light input portion 121 located on one side of the main body portion 110, wherein the main body portion 110 is provided with a first light output region 101, the first light input portion 121 is used for receiving and guiding a first light beam from a first light source 210 into the main body portion 110, and the first light beam is guided and propagated in the main body portion 110 and ultimately exits as first functional light from the first light output region 101. One or more first light input portions may be arranged according to actual needs.

When a light guide component is applied to a lighting or signal indication device, for example, a vehicle lamp in a motor vehicle, as shown in FIG. 1, the light guide component 100 may be installed on a decorative ring 300 of the vehicle lamp, so that the first light output region 101 is exposed in front of the decorative ring 300, and light emitted from the first light output region 101 may be cast to the front of the vehicle directly or through a projection optical device (for example, a projection lens or a light distribution mirror) to provide a desired lighting or signal indication function.

In an exemplary embodiment of the present disclosure, the light guide component 100 may further provide or guide light emergence with additional lighting or signal indication functions, so that a plurality of functions may be fulfilled using the same component. As an example, as shown in FIG. 1-5, a second light output region 102 is further defined or provided on the main body portion 110 of the light guide component 100, the light guide component 100 further comprises a second light input portion 122 and a reflective portion 130, the second light input region 122 is used for receiving and guiding a second light beam from a second light source 220 into the main body portion 110 so that the light beam propagates or travels towards the reflective portion 130, while the reflective portion 130 receives the second light beam from the second light source 220 that enters the main body portion 110 through the second light input region 122 and reflects the second light beam towards the second light output region 102, so that the second light beam exits from the second light output region 102 as second functional light.

As shown in FIG. 1, when the light guide component 100 may be installed on the decorative ring 300 of a vehicle lamp, the second light output region 102 may be exposed on a side of the decorative ring 300, and light emitted from the second light output region 102 may be cast on the side of the vehicle to provide a desired lighting or signal indication function directly or through a projection optical device (for example, a projection lens or a light distribution mirror).

Second functional light emitted from the same light guide component is different from first functional light, which means that second functional light and first functional light are used to fulfil different lighting or signal indication functions, respectively. One or more second light input portions and/or reflective portions may be arranged according to actual needs.

Therefore, the light guide component 100 according to an exemplary embodiment of the present disclosure can provide or guide light emergence with two different lighting or signal indication functions, thereby allowing a reduction in the volume of and installation space required by an optical module compared with a conventional technique of arranging separate light guide components for each lighting or signal indication function, and fulfilling two or more functions on the same light guide component, which means that the same light guide component may be integrated with two or more diverse lighting or signal indication functions to reduce module costs and assembly complexity. For example, first functional light may comprise one of a dipped beam, full beam, daytime running light beam, parking light beam, etc. for motor vehicles, while second functional light may comprise an auxiliary headlamp beam for motor vehicles, for example, a light beam for a corner lamp, side marker lamp, sealed beam lamp (SBL), decorative lamp, or another customized lighting effect.

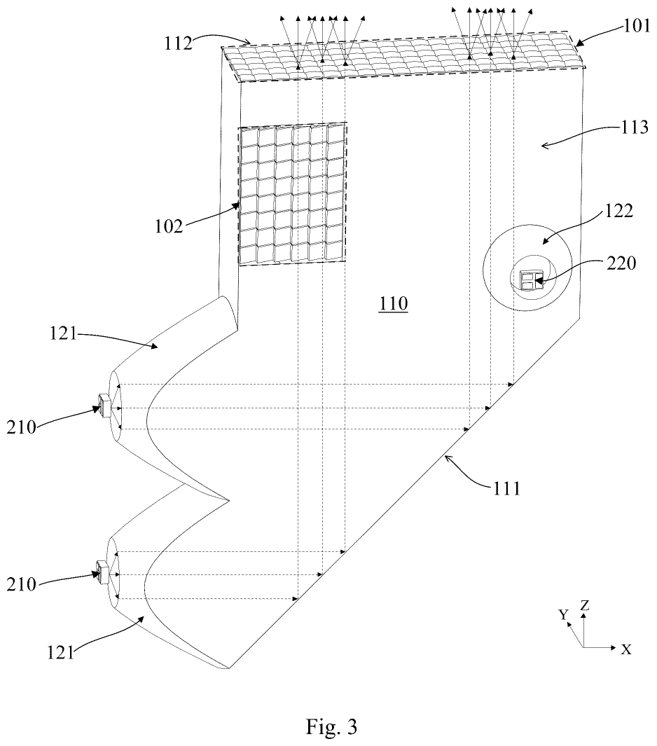

A light guide component may be constructed in a plurality of manners to guide light within the light guide component or the main body portion thereof. In the illustrated embodiment, as shown in FIG. 1-5, the main body portion 110 of the light guide component 100 may be a flat main body portion with a first reflective surface 111 and a light output end face 112, wherein the first reflective surface 111 and the light output end face 112 are located on the opposite side of the main body portion 110 in a first direction Z, and part or all of the light output end face 112 defines the first light output region 101. Specifically, as shown in FIG. 3, the first light from the first light source 210 is received by the first light input portion 121 and guided into the main body portion 110, propagates or travels to the first reflective surface 111, and is reflected towards the light output end face 112 by the first reflective surface 111 to exit as the first functional light from the first light output region 101.

In the illustrated example, the first light output region 101 has a substantially rectangular shape that extends in a second direction Y and a third direction X perpendicular to the first direction Z, but the present disclosure is not limited thereto, wherein specific shapes of the first light output region may be designed according to actual needs. The first reflective surface 111 and the first light input portion 121 may be located on the opposite side of the main body portion 110 in the third direction X, and the first reflective surface 111 may be inclined relative to the first direction Z or the third direction X to reflect, by total reflection, for example, the first light from the first light input portion 121 towards the light output end face 112.

Herein, the orientation of a light guide component is described with reference to a drawing, and the first direction Z can refer to the direction of emergence or the main axis direction of the first functional light emitted from the first light output region, which can coincide or be consistent with the direction of the optical axis of the projection optical device of the optical module. In some examples, when a light guide component is applied to a lighting or signal indication device, for example, a headlamp in a motor vehicle, the first direction Z mentioned herein may refer to the front-rear direction or longitudinal direction of the vehicle, the second direction Y may refer to the lateral direction of the vehicle, and the third direction X may refer to the vertical direction or height direction of the vehicle, but the present disclosure is not limited thereto.

In the illustrated embodiment, as shown in FIG. 1-5, the second light input portion 122 and the second light output region 102 are located on the same side of the main body portion 110 and on the opposite side of the reflective portion 130, so that the second light beam from the second light source 220 enters the main body portion 110 through the second light input portion 122 and continues to propagate or travel towards the reflective portion 130, and the second light enters the main body portion 110 again after being reflected (by total reflection, for example) by the reflective portion 130, and finally exits from the second light output region 102. The first light input portion 121 and the first light output region 101 may also be arranged on the side of the main body portion 110 that is different from the second light input portion, the reflective portion, and the second light output region. As needed, the second light output region 102 may be adjacent or close to the first light output region 101. Thus, the different sides of the light guide component may be fully utilized to arrange the first light input portion, the second light input portion, the reflective portion, the first light output region, and the second light output region, which is conducive to further reducing the size of the light guide component and reducing the mutual interference or impact between the guidance, propagation, and emergence of the first and second light in the main body portion, thereby reducing the mutual interference between the emergent first and second functional light, which means that the lighting effects achievable respectively remain unaffected.

For example, as shown in FIG. 1-5, the main body portion 110 further has a first surface 113 and a second surface 114 opposite each other in the second direction Y, and the first surface 113 and the second surface 114 may be adjacent to the first reflective surface 111 and the light output end face 112. A second light output region 102 is defined on the first surface 113, and the second light input portion 122 is formed on the first surface 113 separating from the second light output region 102, while the reflective portion 130 is formed on the opposite second surface 114.

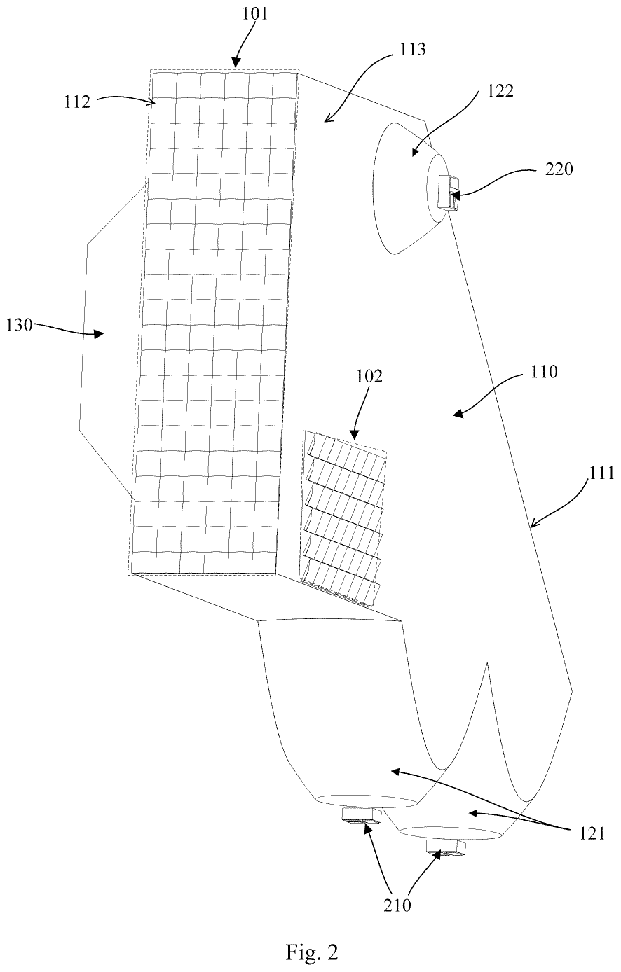

In order to guide the second light from the second light source 220 to propagate in the main body portion 110 and ultimately exit from the second light output region 102, the reflective portion 130 is provided with at least two reflective surfaces, comprising a second reflective surface 131 and a third reflective surface 132, as shown in FIGS. 2, 4, and 5. The second reflective surface 131 may be constructed and arranged to reflect the second light from the second light source 220 that propagates through the main body portion 110 towards the third reflective surface 132, and the third reflective surface 132 may be constructed and arranged to reflect the second light reflected from the second reflective surface 131 into the main body portion 110, so that the light passes through the main body portion 110 again, and finally exits from the second light output region 102.

The second reflective surface 132 and the third reflective surface 132 may be located on the opposite side of the reflective portion 130 in the third direction X, and perform total internal reflection of the second light within the reflective portion 130 to reduce light loss or leakage.

The reflective portion 130 may be arranged or constructed in various forms to ensure that the second light from the second light source 220 is guided and propagated in the main body portion 110, and then exits from the second light output region 102 located on the same side as the second light source 220. As an example, as shown in FIGS. 2, 4, and 5, the reflective portion 130 is formed as a boss protruding from the second surface 114 of the main body portion 110, wherein the boss may have a substantially trapezoidal cross section in a plane perpendicular to the first direction Z, and the lines intersecting the second reflective surface 131 and the third reflective surface 132 with the plane respectively define the sides of the trapezoidal cross section. However, the present disclosure is not limited thereto, wherein, for example, the reflective portion may also be formed as a protrusion with a triangular cross section or another polygonal cross section.

The second functional light exiting from the second light output region 102, after being guided and reflected by the reflective portion 130, may have a direction or optical axis different from (for example, being perpendicular to or inclined towards) the direction or optical axis of the first functional light exiting from the first light output region 101. For example, the first functional light exiting from the first light output region 101 may be directed towards the front of the vehicle to provide main lighting or indication, while the second functional light exiting from the second light output region 102 may be directed towards a side of the vehicle to provide auxiliary lighting or indication.

In some applications, such as in vehicle applications, it may be desirable for the second function light exiting from the second light output region to slightly slant towards the front or rear of the vehicle, so that any pedestrians or drivers around the vehicle, especially those in front of or behind the vehicle, can see the vehicle. Therefore, as shown in FIG. 3, the second reflective surface 131 and the third reflective surface 133 of the reflective portion 130 may be tilted relative to the second direction Y, so that the distance therebetween in the third direction X gradually increases in the direction of or direction opposite the emergence of the first functional light 1, which allows the second light reflected by the tilted third reflective surface 133 to have different emergence directions.

In other words, the area of the trapezoidal or any other polygonal cross section of the reflective portion 130 in the plane perpendicular to the first direction Z gradually increases in the direction of or direction opposite the emergence of the first functional light from the first light output region 101, so the reflective portion 130 is formed as a structure with one side narrow and the opposite other side wide, Parts of the second reflective surface 131 and third reflective surface 133 on the narrow side guide and reflect the second light to exit in a direction that is inclined towards, rather than being perpendicular to, the direction in which the first functional light exits from the first light output region 101, so that the angle between the direction in which a part of the second functional light exits from the second light output region 102 and the direction in which the first functional light exits from the first light output region 101 is greater than 0 degrees and smaller than 90 degrees, or greater than 90 degrees and smaller than 180 degrees. Correspondingly, in the first direction Z, the second light output region 102 may be closer to or further away from the light output end face 112 than the second light input portion 122.

In a further embodiment, a light distribution structure may be formed or arranged in the second light output region 102, wherein the light distribution structure is configured to shape the emergent second light into second functional light with a desired light distribution. For example, the light distribution structure may comprise an optical pattern structure, like a stripe structure, for example, a grating lens, for extending emergent second light. Similar light distribution structures may also be formed or arranged in the first light output region 101, comprising a plurality of optical microstructures such as protrusions, pillows, or stripes, which have outer surfaces in the shapes of cones, spheres, ellipsoids, triangular pyramids, and pentagonal pyramids, for example.

In order to improve light utilization efficiency, at least one of the first light input portion and second light input portion may be included or arranged as a light collimating portion.

In embodiments of the present disclosure, although different parts of the light guide component 100 are described with reference to the drawings, the light guide component 100, for example, may be an integral solid structure, such as a flat component, and may, for example, be made of materials such as resin and plastic, like polycarbonate or polymethyl methacrylate, but embodiments of the present disclosure are not limited thereto. It will be understood that the expression “reflective surface” mentioned herein can refer to an interface or inner wall surface between the physical portion of the light guide component and air or another dielectric material.

Embodiments of the present disclosure further provide an optical module comprising a first light source 210, a second light source 220 and a light guide component 100, for example, a lighting or signal indication device, like a vehicle lamp for the lighting or signal indication of a vehicle, wherein the first light source 210 is used to provide the first light to the first light input portion 121 of the light guide component 100, and the second light source 220 is used to provide the second light to the second light input portion 122 of the light guide component 100, so that the same module or device is integrable with or fulfils two or more lighting or signal indication functions, which allows a reduction of module costs and assembly complexity. For example, the first functional light formed by the first light emitted from the light guide component may comprise one of a dipped beam, full beam, daytime running light beam, parking light beam, etc. for motor vehicles, while the second functional light formed by the first light emitted from the light guide component may comprise an auxiliary headlamp beam for motor vehicles, for example, a light beam for a corner lamp, side marker lamp, sealed beam lamp (SBL), decorative lamp, or another customized lighting effect.

Embodiments of the present disclosure further provide a motor vehicle comprising a light guide component or lighting or signal indication device as described in any one embodiment.

Although the present disclosure has been explained in conjunction with the drawings, the embodiments disclosed in the drawings are intended to provide an exemplary illustration of preferred embodiments of the present disclosure, and must not be interpreted as a limitation of the present disclosure. The dimensional proportions in the drawings are merely schematic and must not be interpreted as limitations to the present disclosure.

While some embodiments of the general idea of the present disclosure have been shown and explained above, those of ordinary skill in the art will understand that modifications may be made to these embodiments without departing from the principles or spirit of the general invention idea and that the scope of the present disclosure is defined by the claims and equivalents thereof.

What is claimed is:

1. A light guide component, comprising:
a main body portion provided with a first light output region and a second light output region; and
a first light input portion configured to receive and guide a first light beam from a first light source into the main body portion, so that the first light beam is guided in the main body portion and exits from the first light output region to fulfil a first light function;
second light input portion and a reflective portion,
the second light input portion is configured to receive and guide a second light beam from a second light source into the main body portion and propagate the second light beam towards the reflective portion, and
the reflective portion is configured to receive the second light beam and reflect the second light beam towards the second light output region to fulfil a second light function different from the first light function.

2. The light guide component according to claim 1, wherein
the main body portion has a first reflective surface and a light output end face, the first light output region is defined on the light output end face, and
the first reflective surface is arranged such that the first light beam entering the main body portion through the first light input portion is reflected by the first reflective surface towards the light output end face to exit from the first light output region.

3. The light guide component according to claim 1, wherein
the second light input portion and the second light output region are located on a side of the main body portion opposite the reflective portion, so that the second light beam from the second light source enters the main body portion through the second light input portion and continues to propagate towards the reflective portion, and, after being reflected by the reflective portion, the second light beam enters the main body portion again to exit from the second light output region.

4. The light guide component according to claim 3, wherein
the main body portion includes a first surface and a second surface that are arranged opposite each other, the first and second surfaces being adjacent to a first reflective surface and a light output end face,
the second light output region is defined on the first surface,
the second light input portion is formed on the first surface separate from the second light output region, and
the reflective portion is formed on the second surface.

5. The light guide component according to claim 4, wherein
the reflective portion has a second reflective surface and a third reflective surface arranged opposite each other,
the second reflective surface is configured and arranged to reflect the second light beam propagating through the main body portion towards the third reflective surface, and
the third reflective surface is configured and arranged to reflect the second light beam reflected from the second reflective surface into the main body portion so that the light beam exits from the second light output region.

6. The light guide component according to claim 5, wherein
the reflective portion is formed as a boss protruding from the second surface, the boss having a trapezoidal cross section in a plane perpendicular to a first direction, wherein the lines intersecting the second and third reflective surfaces with the plane respectively define the sides of the trapezoidal cross section.

7. The light guide component according to claim 6, wherein
the second reflective surface and the third reflective surface are inclined relative to a second direction, so that the distance therebetween in a third direction gradually increases in the direction of emergence of the first light function.

8. The light guide component according to claim 7, wherein
in the first direction, the second light output region is closer to the light output end face than the second light input portion.

9. The light guide component according to claim 1, wherein
an optical pattern structure is formed in the second light output region, the optical pattern structure being configured to shape an emergent second light beam into a desired light distribution.

10. The light guide component according to claim 1, wherein at least one of the first light input portion and the second light input portion includes a light collimating portion.

11. A lighting or signal indication device, comprising
a light guide component, the light guide component includes a main body portion provided with a first light output region and a second light output region, and a first light input portion configured to receive and guide a first light beam from a first light source into the main body portion. so that the first light beam is guided in the main body portion and exits from the first light output region to fulfil a first light function, a second light input portion and a reflective portion, the second light input portion is configured to receive and guide a second light beam from a second light source into the main body portion and propagate the second light beam towards the reflective portion, and the reflective portion is configured to receive the second light beam and reflect the second light beam towards the second light output region to fulfil a second light function different from the first light function;
the light source for providing a first light beam to the first light input portion; and
the second light source for providing second light to the second light input portion.

12. A motor vehicle, comprising a lighting or signal indication device, with the lighting or signal indication device including a light guide component, the light guide component includes a main body portion provided with a first light output region and a second light output region, and a first light input portion configured to receive and guide a first light beam from a first light source into the main body portion, so that the first light beam is guided in the main body portion and exits from the first light output region to fulfil a first light function. a second light input portion and a reflective portion, the second light input portion is configured to receive and guide a second light beam from a second light source into the main body portion and propagate the second light beam towards the reflective portion, and the reflective portion is configured to receive the second light beam and reflect the second light beam towards the second light output region to fulfil a second light function different from the first light function, the first light source for providing a first light beam to the first light input portion, and the second light source for providing second light to the second light input portion.
